(19) United States
(12) Patent Application Publication
(10) Pub. No.: US 2026/0290819 A1
(43) Pub. Date: Sep. 24, 2026

(54) METHOD FOR PRODUCING CATHODE ACTIVE MATERIAL

(71) Applicant: TOYOTA JIDOSHA KABUSHIKI KAISHA, Toyota-shi (JP)

(72) Inventor: Takanori Mahara, Toyota-shi (JP)

(73) Assignee: TOYOTA JIDOSHA KABUSHIKI KAISHA, Toyota-shi (JP)

(21) Appl. No.: 19/450,367

(22) Filed: Jan. 15, 2026

(30) Foreign Application Priority Data
Jan. 22, 2025 (JP) 2025-009119

(51) Int. Cl. H01M 4/587; C01B 25/45; H01M 4/36; H01M 4/58

(52) U.S. Cl. CPC H01M 4/587; C01B 25/45; H01M 4/366; H01M 4/5825; C01P 2004/50; C01P 2006/40

(57) ABSTRACT

A method for producing a cathode active material includes: (a) preparing secondary particles that are each an aggregate of primary particles; and (b) infiltrating molten carbon obtained by melting a carbon material between the primary particles. The primary particles each include an olivine phosphate compound, and carbon adheres to at least part of a surface of each of the primary particles.

### CROSS-REFERENCE TO RELATED APPLICATION

This application claims priority to Japanese Patent Application No. 2025-009119 filed on Jan. 22, 2025. The disclosure of the above-identified application, including the specification, drawings, and claims, is incorporated by reference herein in its entirety.

### BACKGROUND

### 1. Technical Field

The present disclosure relates to a method for producing a cathode active material.

### 2. Description of Related Art

Japanese Unexamined Patent Application Publication No. 2003-203628 (JP 2003-203628 A) discloses that a conductive path made of carbon is incorporated inside a particle of a cathode active material containing an olivine phosphate compound, and that the conductive path made of carbon is incorporated by firing a mixture of an olivine phosphate compound material and an organic substance.

### SUMMARY

Olivine phosphate compounds have been investigated as cathode active materials. Hitherto, it has been proposed that the electronic conductivity can be increased by coating primary particles of an olivine phosphate compound with carbon.

With the method described in JP 2003-203628 A, however, it is difficult to infiltrate carbon deep into the olivine phosphate compound having high density. Therefore, poor conductivity may cause deterioration of battery characteristics.

An object of the present disclosure is to provide a method for producing a cathode active material in which carbon is uniformly infiltrated even inside.

Technical configurations and functions and effects of the present disclosure will be described below. Note, however, that mechanisms of action according to the present disclosure include estimation. The mechanisms of action do not limit the technical scope of the present disclosure.

[1] A method for producing a cathode active material, the method including:
(a) preparing secondary particles that are each an aggregate of primary particles; and
(b) infiltrating molten carbon obtained by melting a carbon material between the primary particles, in which
the primary particles each include an olivine phosphate compound, and
carbon adheres to at least part of a surface of each of the primary particles.

With the molten carbon, it is expected that a cathode active material in which carbon is uniformly infiltrated even inside can be obtained. It is also expected that a decrease in capacity due to use of a battery using such a cathode active material can be suppressed.

[2] The method for producing the cathode active material according to [1], in which the carbon material is pitch.

Any carbon material can be used as long as it contains carbon. Examples of the carbon material include pitch.

[3] The method for producing the cathode active material according to [1] or [2], in which the (b) infiltrating includes heating a mixture of the carbon material and the secondary particles in a reduced pressure environment.

By heating the mixture of the carbon material and the secondary particles in the reduced pressure environment, it is expected that carbon can be infiltrated more uniformly.

[4] The method for producing the cathode active material according to any one of [1] to [3], in which a maximum Feret diameter of each of the primary particles is 100 nm or less.

[5] The method for producing the cathode active material according to any one of [1] to [4], in which an amount of the carbon material is 0.5% or more and 5% or less by mass with respect to the secondary particles.

With the specific amount of the carbon material with respect to the secondary particles, it is expected that carbon can be infiltrated uniformly.

An embodiment of the present disclosure (hereinafter may be abbreviated to “present embodiment”) will be described below. Note, however, that the present embodiment does not limit the technical scope of the present disclosure. The present embodiment is exemplary in all respects. The present embodiment is non-limiting. The technical scope of the present disclosure includes all modifications that fall within the meaning and scope equivalent to the claims. For example, it is planned from the beginning to extract optional configurations from the present embodiment and the Examples, and optionally combine these configurations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flowchart of a method for producing a cathode active material according to the present embodiment; and

FIG. 2 is a table showing production conditions and experiment results of cathode active materials in the Examples.

### DETAILED DESCRIPTION OF EMBODIMENTS

### Terms and Phrases

“Comprise,” “include,” “have,” and variations thereof are open ended expressions. A configuration expressed as open ended may or may not further include additional elements in addition to essential elements.

“D50” indicates the particle size at which a cumulative value becomes 50% in a volume-based particle size distribution (cumulative distribution). D50 can be measured by, for example, a laser diffraction particle size distribution measuring device.

The “maximum Feret diameter” refers to the length of the long side of a circumscribing quadrangle (rectangle or square) of a particle. When the circumscribing quadrangle is a square, the length of the long side indicates the length of one side.

### Method for Producing Cathode Active Material

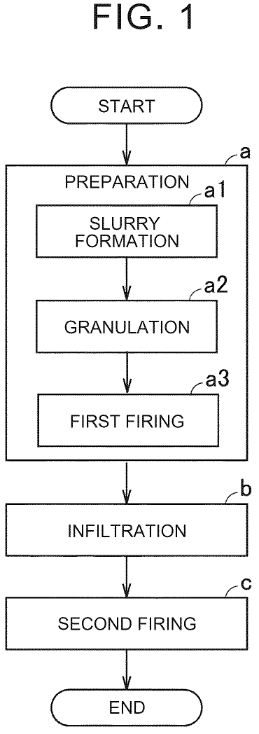

FIG. 1 is a schematic flowchart of a method for producing a cathode active material according to the present embodiment. Hereinafter, the “method for producing a cathode active material according to the present embodiment” may be abbreviated to “present production method.” The present production method includes “(a) preparation” and “(b) infiltration.” In the present production method, “(a) preparation” may further include, for example, “(a1) slurry formation,” “(a2) granulation,” and “(a3) first firing.” The present production method may further include, for example, “(c) second firing.”

### (a) Preparation

The present production method includes preparing a secondary particle that is an aggregate of primary particles. The primary particle contains an olivine phosphate compound. Carbon adheres to at least part of the surface of the primary particle.

The cathode active material contains the secondary particle. The cathode active material may be an aggregate of a plurality of secondary particles. That is, the cathode active material may be in the form of a powder. The D50 of the powder may be, for example, 5 μm or more, 10 μm or more, 15 μm or more, or 20 μm or more. The D50 may be, for example, 30 μm or less, 25 μm or less, 20 μm or less, or 15 μm or less.

The secondary particle may have any shape. The secondary particle may have, for example, a spherical shape, a rod shape, or an angular shape. The spherical secondary particle is expected to improve, for example, filling properties. The sphericity of the secondary particle may be, for example, 0.85 or more, 0.90 or more, or 0.95 or more. The sphericity of the secondary particle may be, for example, 1 or less, 0.95 or less, or 0.90 or less. The “sphericity” refers to the circularity in a scanning electron microscope (SEM) image (two-dimensional image). The sphericity (circularity) is determined by the following expression.

$$ψ = 4 π S / {L}^{2}$$

ψ: Sphericity (circularity)
π: circle ratio
S: sectional area of secondary particle (area of region surrounded by outline of secondary particle)
L: perimeter of secondary particle (length of outline of secondary particle)

The sphericity is an arithmetic average of 30 secondary particles.

The secondary particle is an aggregate of the primary particles. The primary particle may have any shape. The primary particle may have, for example, a spherical shape, a rod shape, or an angular shape. The primary particle may be a nanoparticle. The maximum Feret diameter of the primary particle may be, for example, 100 nm or less. The maximum Feret diameter of the primary particle may be, for example, 80 nm or less, or 60 nm or less. The maximum Feret diameter of the primary particle may be, for example, 10 nm or more, 20 nm or more, 30 nm or more, 40 nm or more, 50 nm or more, 60 nm or more, 70 nm or more, or 80 nm or more. The maximum Feret diameter of the primary particle is an arithmetic average of 30 primary particles.

Carbon adheres to at least part of the surface of the primary particle. Carbon may form a carbon layer. The adhesion amount of carbon may be, for example, 0.1% or more, 0.5% or more, 1% or more, 2% or more, 3% or more, or 4% or more by mass with respect to the secondary particle. The adhesion amount of carbon may be, for example, 5% or less, 4% or less, or 3% or less by mass with respect to the secondary particle.

The primary particle contains the olivine phosphate compound. “Olivine” refers to a crystal structure belonging to the space group Pnma. The space group is identified by powder X-ray diffraction (XRD) measurement. The primary particle may be, for example, a single-phase compound. As long as the primary particle contains the olivine crystal phase, it may further contain a phase belonging to another space group. The primary particle may further contain, for example, an amorphous phase.

The olivine phosphate compound may include, for example, lithium iron phosphate (LFP) or lithium manganese phosphate (LMP). In the LMP, part of the manganese (Mn) may be substituted with iron (Fe). An Fe-substituted form of the LMP is also referred to as lithium manganese iron phosphate (LMFP). The LMP may have, for example, a composition represented by the following general formula.

Li₁₋ₐMn₁₋ₓFeₓPO₄

For example, relationships of −0.5≤a≤0.5 and 0≤x≤1 may be satisfied.

### (a1) Slurry Formation

The present method may include, for example, forming a slurry by mixing a lithium compound, a manganese compound, an iron compound, a phosphate compound, a carbon source, and a solvent. For example, the lithium compound, the manganese compound, the phosphate compound, and the iron compound may be weighed to achieve a composition ratio (mole ratio) represented by the composition formula “Li₁₋ₐMn₁₋ₓFeₓPO₄ (−0.5≤a≤0.5, 0≤x≤1).” The lithium compound may include, for example, lithium carbonate or lithium hydroxide. The manganese compound may include, for example, manganese carbonate. The phosphate compound may include, for example, phosphoric acid or lithium dihydrogen phosphate. The iron compound may include, for example, iron oxalate or ferric phosphate.

The carbon source is the source of carbon that adheres to the surface of the primary particle. The carbon source may include, for example, sugars or organic acids. The carbon source may include, for example, glucose, sucrose, fructose, citric acid, or lactic acid. The carbon source may include, for example, sugars. The addition amount of the carbon source may be, for example, 1% to 20% by mass with respect to the raw material mixture. The carbon source may be added after granules are formed using a raw material mixture of other raw materials. In this case, the addition amount of the carbon source may be, for example, 1% to 20% by mass with respect to the granules.

The carbon source is preferably contained in this step in addition to the carbon material described later. Thus, carbon can adhere to the surface of the primary particle in advance, and can further adhere to the surface of the primary particle in step (b), which is expected to result in more uniform infiltration of carbon.

The solvent may include, for example, water. The solid content concentration of the slurry may be, for example, 20% to 40% by mass.

The particle size in the slurry may be adjusted by performing wet milling. For example, the wet milling may be performed such that the D50 is 0.10 μm to 1 μm.

### (a2) Granulation

The present method may include obtaining secondary particles by granulation using, for example, drying of the slurry. For example, the secondary particles may be obtained by granulation using a spray drying method. The secondary particles formed by the granulation operation are also referred to as “granules.” That is, the secondary particles may be rephrased as “granules.”

### (a3) First Firing

The present method may include forming precursor particles by subjecting the secondary particles to heat treatment (first firing). Any heat treatment furnace (e.g., an electric furnace or a muffle furnace) can be used. The heat treatment atmosphere may be, for example, an inert atmosphere. The inert atmosphere may be, for example, a nitrogen atmosphere. The heat treatment temperature may be, for example, 400° C. to 700° C. The heat treatment time may be, for example, 1 hour to 6 hours.

### (b) Infiltration

The present production method includes infiltrating molten carbon obtained by melting a carbon material between the primary particles.

Any carbon material can be used as long as it contains carbon. Examples of the carbon material include pitch. The carbon material may have a softening point of, for example, 50° C. to 150° C., or 100° C. to 120° C.

The melting temperature may be adjusted as appropriate depending on the carbon material. The melting temperature may be, for example, a temperature higher than the softening point of the carbon material. For example, when the softening point of the carbon material is 110° C., the melting may be performed at about 150° C.

The melting of the carbon material may be performed, for example, in a reduced pressure environment. The melting of the carbon material may be performed, for example, under vacuum. By performing this step in such an environment, it is expected that carbon can be infiltrated more uniformly.

The infiltration of molten carbon between the primary particles may be performed, for example, by mixing the secondary particles (precursor particles) with the molten carbon.

The infiltration of the molten carbon between the primary particles and the melting of the carbon material may be performed simultaneously. For example, after the carbon material is added to the precursor particles to form a mixture, the mixture may be heated (melted). For example, the mixture may be heated in a reduced pressure environment or under vacuum. By simultaneously performing the infiltration of the molten carbon between the primary particles and the melting of the carbon material in such an environment in this step, it is expected that carbon can be infiltrated more uniformly.

The amount of the carbon material may be, for example, 0.5% or more and 5% or less by mass with respect to the secondary particles (precursor particles). The amount of the carbon material may be 1% or more and 4% or less, or 1% or more and 3% or less by mass with respect to the secondary particles (precursor particles).

### (c) Second Firing

The present production method may further include performing heat treatment (second firing).

The heat treatment atmosphere may be, for example, an inert atmosphere. The inert atmosphere may be, for example, a nitrogen atmosphere. The heat treatment temperature may be, for example, 400° C. to 700° C. The heat treatment time may be, for example, 1 hour to 6 hours.

### Others

In the present embodiment, the infiltration of carbon into the cathode active material may be evaluated, for example, based on the relaxation rate and the Li elution amount measured by methods described later in the Examples. For example, the relaxation rate of the cathode active material obtained by the present production method may be 2 or more when the relaxation rate of a cathode active material produced in related art is 1. For example, the Li elution amount from the cathode active material obtained by the present production method may be 0.7 or less when the Li elution amount from the cathode active material produced in related art is 1.

### Production of Cathode Active Material

### No. 1

Lithium carbonate, manganese carbonate, iron oxalate, and phosphoric acid were weighed to achieve the composition ratio represented by the composition formula “Li₁Mn_{0.8}Fe_{0.2}PO₄.” These raw materials were dispersed in water to form a slurry, which was then pulverized in a bead mill using beads each having a diameter of 0.3 mm at a peripheral speed of 10 m/sec for 30 minutes, and then fired to obtain granules. Fructose was added to the granules in an amount of 10% by mass. After drying, this prepared liquid was heated to a firing temperature of 650° C. at a temperature rising rate of 5° C./min in an inert atmosphere, maintained at this temperature for 1 hour, and then cooled to room temperature to obtain precursor particles.

The obtained precursor particles were again heated to a firing temperature of 600° C. at a temperature rising rate of 5° C./min in an inert atmosphere, maintained at this temperature for 1 hour, and then cooled to room temperature to produce a cathode active material (LMFP).

### No. 2

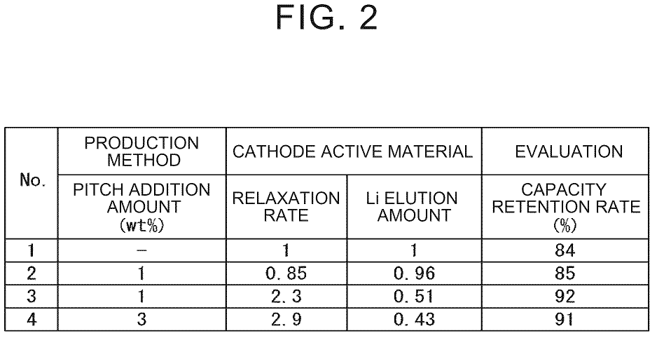

Precursor particles were formed by the same process as in No. 1. Pitch (softening point: 110° C.) was added to the precursor particles in the mass fraction shown in FIG. 2 to form a mixture. The mixture was stirred and mixed in a mixer (product name: “Awatori Rentaro,” manufactured by Thinky Corporation) at a stirring rate of 2000 rpm for 1 minute.

The obtained mixture was heated to a firing temperature of 600° C. at a temperature rising rate of 5° C./min in an inert atmosphere, maintained at this temperature for 1 hour, and then cooled to room temperature to produce a cathode active material.

### No. 3

A mixture was formed and then stirred and mixed by the same process as in No. 2. The mixture was heated (melted) at 150° C. in a vacuum drying vessel along with evacuation. Then, the mixture was fired under the same conditions as in No. 2 to produce a cathode active material.

### No. 4

A cathode active material was produced in the same manner as in No. 3, except that pitch was added to the precursor particles in the mass fraction shown in FIG. 2.

### Measurement

### Relaxation Rate

The cathode active material of each number was dispersed in a solvent from which an electrolyte was removed, and measurement was performed by time-domain nuclear magnetic resonance (TD-NMR). A normalized relaxation rate was determined by comparing the time taken for the initial magnetization intensity to decrease to 20%. The results are shown in FIG. 2. The relaxation rates in FIG. 2 are relative values when the relaxation rate of No. 1 is 1.

### Li Elution Amount

The cathode active material of each number was dispersed at 0.1 g in 50 g of water and then left standing for 24 hours. After standing, the cathode active material was removed by filtration through a 0.2 μm membrane filter to obtain a filtrate. The Li elution amount was determined by measuring the Li concentration in the filtrate by ICP-Optical Emission Spectroscopy (ICP-OES). The results are shown in FIG. 2. The Li elution amounts in FIG. 2 are relative values when the Li elution amount of No. 1 is 1.

### Battery Characteristics

### Production of Coin Cell

The cathode active material, a conductive material (acetylene black), and a binder (PVdF) were mixed to form a mixture. The mixing ratio (mass ratio) was “cathode active material/conductive material/binder=92/5/3.” The mixture was dispersed in a solvent (N-methyl-2-pyrrolidone) to form a paste. The solid content concentration of the paste was 50% by mass. The paste was applied to the surface of an aluminum foil and dried to form a cathode layer. The density of the cathode layer was adjusted to 1.8 g/cm³ by roll pressing to form a cathode blank. The cathode blank was subjected to vacuum drying treatment at 120° C. for 12 hours. After drying, a disc sample (14 mm in diameter) was obtained from the cathode blank by punching.

A coin cell was assembled in a glove box. The cell configuration is as follows.
Working electrode: disc sample (cathode)
Counter electrode: Li foil
Separator: porous polymer membrane
Electrolyte solution: “Ethylene carbonate/dimethyl carbonate=3/7 (volume ratio),” LiPF₆ (1 mol/L)

### Capacity Retention Rate

For the obtained coin cell, 1 C was calculated based on the discharge capacity estimated from the application weight. “C” is a symbol indicating the rate (time rate) of current. At a rate of 1 C, the theoretical capacity is discharged in one hour. In an environment of 25° C., the charging rate was set to 0.1 C, the upper limit voltage was set to 4.3 V, and the charging termination condition was set to 0.01 C. After CCCV charging, the 0.1 C discharge capacity (referred to as “first discharge capacity”) was determined when the discharge termination potential was set to 3 V. Then, the battery was again fully charged and then held at a temperature of 60° C. for 14 days. The 0.1 C discharge capacity (referred to as “second discharge capacity”) was determined again, and the capacity retention rate was calculated as “(second discharge capacity/first discharge capacity)×100%.” The results are shown in FIG. 2. It is believed that the durability is better as the capacity retention rate increases.

### Results

As shown in FIG. 2, when the production conditions of the present disclosure are satisfied, the relaxation time tends to increase and the Li elution amount tends to decrease. That is, it is believed that carbon is uniformly infiltrated even inside. When the production conditions of the present disclosure are satisfied, the capacity retention rate tends to increase.

What is claimed is:

1. A method for producing a cathode active material, the method comprising:
(a) preparing secondary particles that are each an aggregate of primary particles; and
(b) infiltrating molten carbon obtained by melting a carbon material between the primary particles, wherein
the primary particles each include an olivine phosphate compound, and
carbon adheres to at least part of a surface of each of the primary particles.

2. The method for producing the cathode active material according to claim 1, wherein the carbon material is pitch.

3. The method for producing the cathode active material according to claim 1, wherein the (b) infiltrating includes heating a mixture of the carbon material and the secondary particles in a reduced pressure environment.

4. The method for producing the cathode active material according to claim 1, wherein a maximum Feret diameter of each of the primary particles is 100 nm or less.

5. The method for producing the cathode active material according to claim 1, wherein an amount of the carbon material is 0.5% or more and 5% or less by mass with respect to the secondary particles.
